(19) United States
(12) Patent Application Publication
(10) Pub. No.: US 2023/0068844 A1
(43) Pub. Date: Mar. 2, 2023

(54) CHANNEL AWARE TONE RESERVATION FOR SIDELINK COMMUNICATIONS

(71) Applicant: QUALCOMM Incorporated, San Diego, CA (US)

(72) Inventors: Idan Michael HORN, Hod Hasharon (IL); Gideon Shlomo KUTZ, Ramat Hasharon (IL); Shay LANDIS, Hod Hasharon (IL)

(21) Appl. No.: 17/446,250

(22) Filed: Aug. 27, 2021

(51) Int. Cl. H04W 72/08; H04L 5/00; H04L 25/02; H04W 76/10; H04W 72/04; H04W 24/08

(52) U.S. Cl. CPC H04W 72/085; H04L 5/0051; H04L 25/022; H04W 24/08; H04W 72/048; H04W 76/10

(57) ABSTRACT

Various aspects of the present disclosure generally relate to wireless communication. In some aspects, a transmitting device may receive sidelink reference signals from a receiving device. The transmitting device may transmit, to the receiving device and via a transmission channel, a unicast sidelink communication having tone reservation applied based at least in part on the sidelink reference signals. Numerous other aspects are described.

### FIELD OF THE DISCLOSURE

Aspects of the present disclosure generally relate to wireless communication and to techniques and apparatuses for channel aware tone reservation for sidelink communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a transmitting device. The method may include receiving sidelink reference signals from a receiving device. The method may include transmitting, to the receiving device and via a transmission channel, a unicast sidelink communication having tone reservation applied based at least in part on the sidelink reference signals.

Some aspects described herein relate to a method of wireless communication performed by a receiving device. The method may include transmitting sidelink reference signals to a transmitting device. The method may include receiving, from the transmitting device and via a transmission channel, a unicast sidelink communication having tone reservation applied based at least in part on the sidelink reference signals.

Some aspects described herein relate to a transmitting device for wireless communication. The transmitting device may include a memory and one or more processors coupled to the memory. The one or more processors may be configured to receive sidelink reference signals from a receiving device. The one or more processors may be configured to transmit, to the receiving device and via a transmission channel, a unicast sidelink communication having tone reservation applied based at least in part on the sidelink reference signals.

Some aspects described herein relate to a receiving device for wireless communication. The receiving device may include a memory and one or more processors coupled to the memory. The one or more processors may be configured to transmit sidelink reference signals to a transmitting device. The one or more processors may be configured to receive, from the transmitting device and via a transmission channel, a unicast sidelink communication having tone reservation applied based at least in part on the sidelink reference signals.

Some aspects described herein relate to a non-transitory computer-readable medium that stores a set of instructions for wireless communication by a transmitting device. The set of instructions, when executed by one or more processors of the transmitting device, may cause the transmitting device to receive sidelink reference signals from a receiving device. The set of instructions, when executed by one or more processors of the transmitting device, may cause the transmitting device to transmit, to the receiving device and via a transmission channel, a unicast sidelink communication having tone reservation applied based at least in part on the sidelink reference signals.

Some aspects described herein relate to a non-transitory computer-readable medium that stores a set of instructions for wireless communication by a receiving device. The set of instructions, when executed by one or more processors of the receiving device, may cause the receiving device to transmit sidelink reference signals to a transmitting device. The set of instructions, when executed by one or more processors of the receiving device, may cause the receiving device to receive, from the transmitting device and via a transmission channel, a unicast sidelink communication having tone reservation applied based at least in part on the sidelink reference signals.

Some aspects described herein relate to an apparatus for wireless communication. The apparatus may include means for receiving sidelink reference signals from a receiving device. The apparatus may include means for transmitting, to the receiving device and via a transmission channel, a unicast sidelink communication having tone reservation applied based at least in part on the sidelink reference signals.

Some aspects described herein relate to an apparatus for wireless communication. The apparatus may include means for transmitting sidelink reference signals to a transmitting device. The apparatus may include means for receiving, from the transmitting device and via a transmission channel, a unicast sidelink communication having tone reservation applied based at least in part on the sidelink reference signals.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of subcarrier tone reservation, in accordance with the present disclosure.

FIGS. 6 and 7 are diagrams illustrating examples associated with subcarrier tone reservation, in accordance with the present disclosure.

FIGS. 8 and 9 are diagrams illustrating example processes associated with channel aware tone reservation for sidelink communications, in accordance with the present disclosure.

FIGS. 10 and 11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

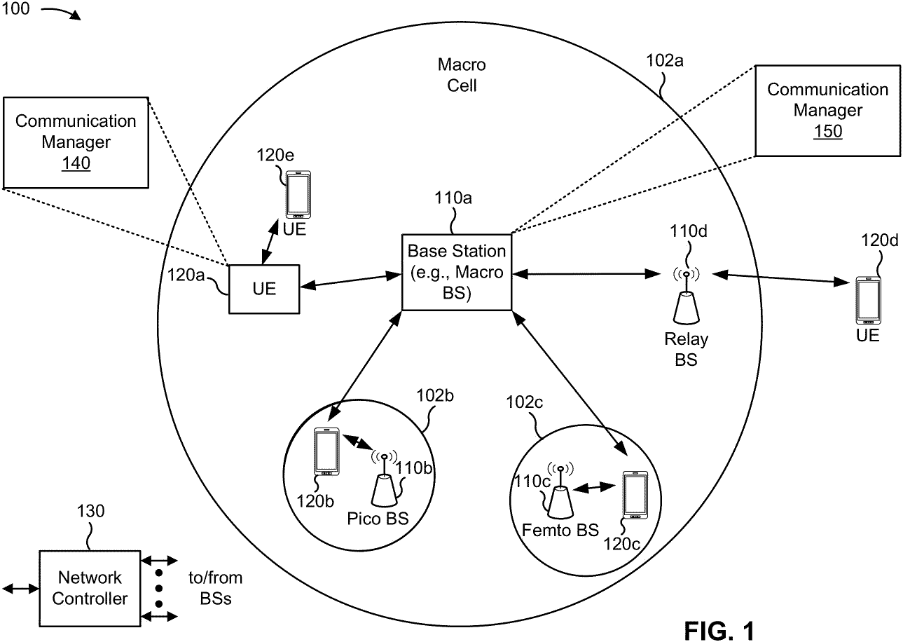

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5GNR, two initial operating bands have been identified as frequency range designations FR1 (410 MHz - 7.125 GHz) and FR2 (24.25 GHz - 52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz - 300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz - 24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz - 71 GHz), FR4 (52.6 GHz - 114.25 GHz), and FR5 (114.25 GHz - 300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a transmitting device (e.g., a UE 120) may include a communication manager 140. As described in more detail elsewhere herein, the communication manager 140 may receive sidelink reference signals from a receiving device; and transmit, to the receiving device and via a transmission channel, a unicast sidelink communication having tone reservation applied based at least in part on the sidelink reference signals. Additionally, or alternatively, the communication manager 140 or 150 may perform one or more other operations described herein.

In some aspects, a receiving device (e.g., a UE 120) may include a communication manager 140. As described in more detail elsewhere herein, the communication manager 140 may transmit sidelink reference signals to a transmitting device; and receive, from the transmitting device and via a transmission channel, a unicast sidelink communication having tone reservation applied based at least in part on the sidelink reference signals. Additionally, or alternatively, the communication manager 150 or 140 may perform one or more other operations described herein.

As indicated above, FIG. 1 is provided as an example. Other examples may differ from what is described with regard to FIG. 1.

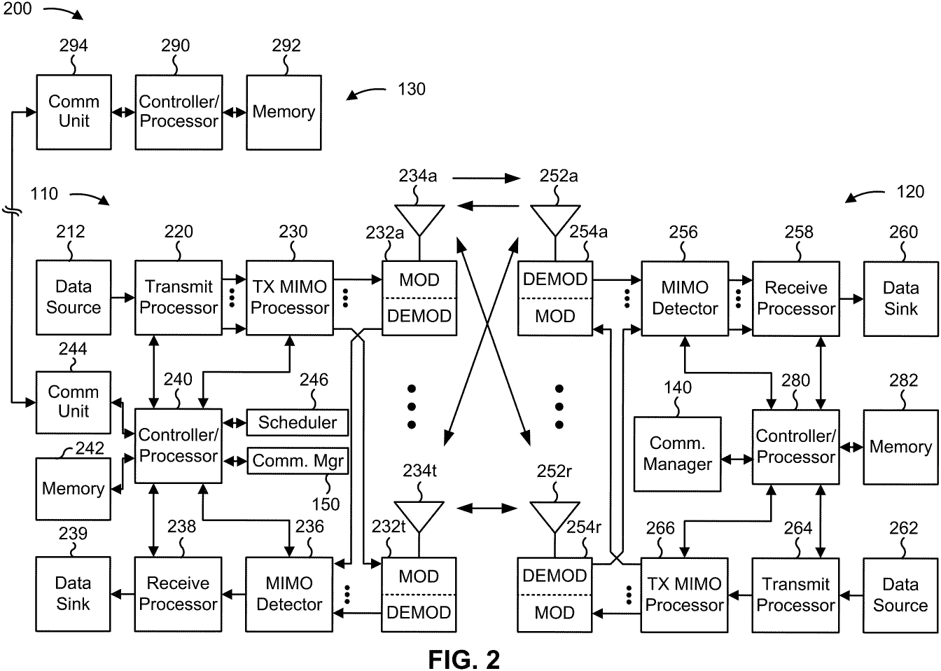

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T ≥ 1). The UE 120 may be equipped with a set of antennas 252a through 252r, such as R antennas (R ≥ 1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

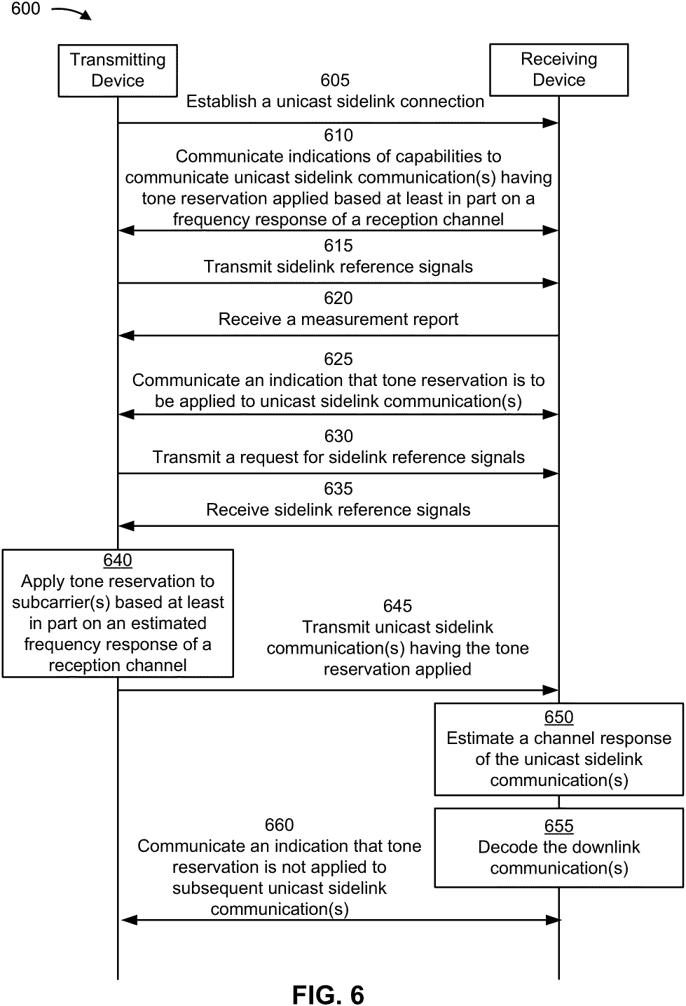

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-11).

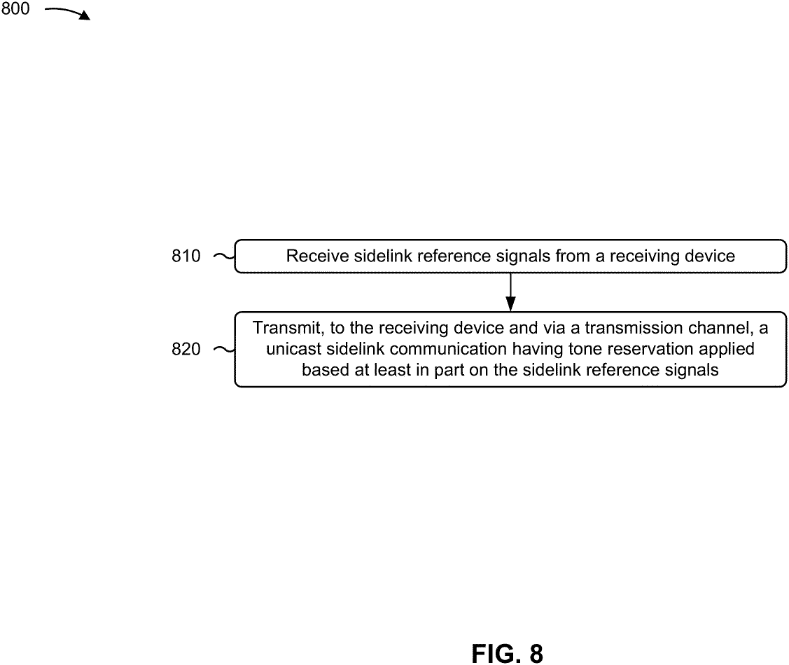

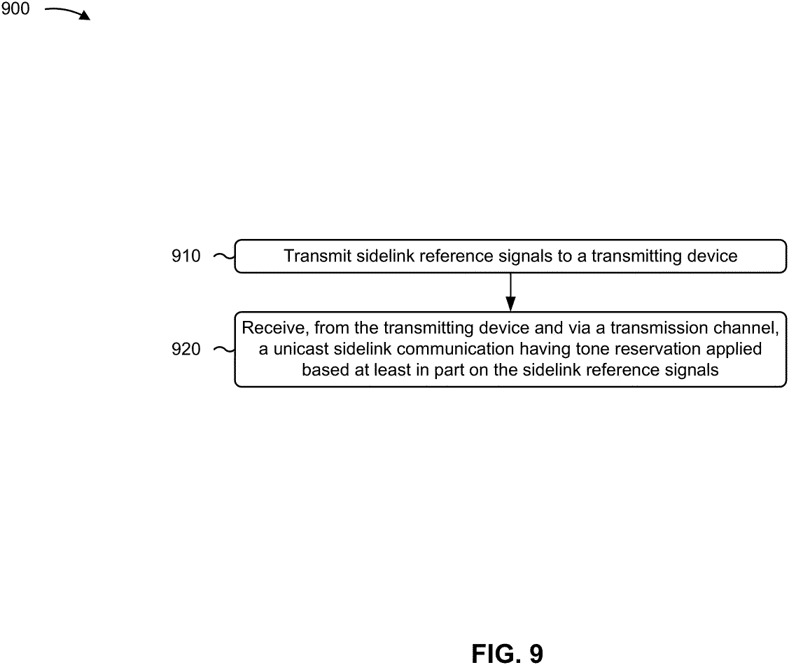

The controller/processor 240 of the base station 110, the controller/processor 280 of the UE 120, and/or any other component(s) of FIG. 2 may perform one or more techniques associated with channel aware tone reservation for sidelink communications, as described in more detail elsewhere herein. In some aspects, the transmitting device described herein is a UE 120, is included in a UE 120, or includes one or more components of a UE 120 shown in FIG. 2. In some aspects, the transmitting device described herein is a UE 120, is included in a UE 120, or includes one or more components of a UE 120 shown in FIG. 2. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the transmitting device includes means for receiving sidelink reference signals from a receiving device; and/or means for transmitting, to the receiving device and via a transmission channel, a unicast sidelink communication having tone reservation applied based at least in part on the sidelink reference signals. In some aspects, the means for the transmitting device to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the receiving device includes means for transmitting sidelink reference signals to a transmitting device; and/or means for receiving, from the transmitting device and via a transmission channel, a unicast sidelink communication having tone reservation applied based at least in part on the sidelink reference signals. In some aspects, the means for the receiving device to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

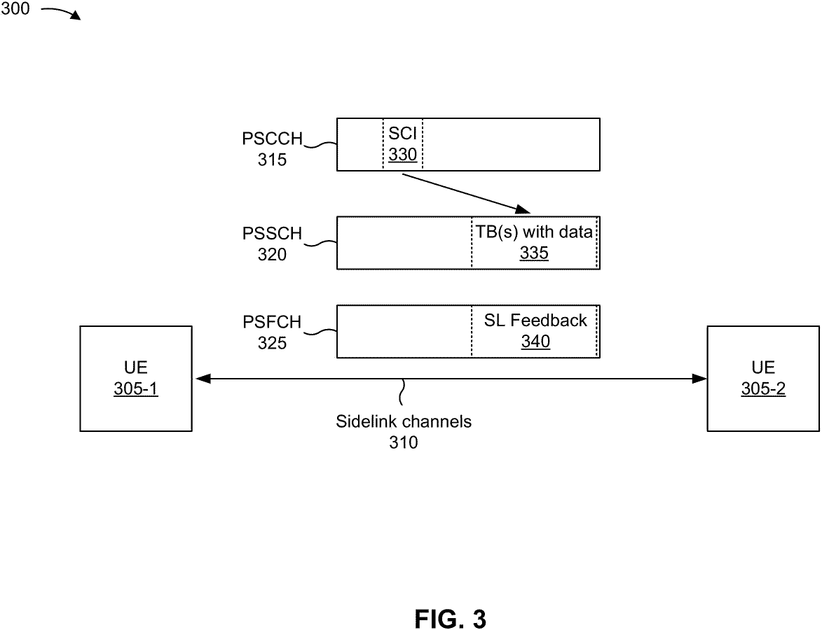

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PSSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a hybrid automatic repeat request (HARQ) process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent resource blocks (RBs) in the same subframe as the scheduling assignment (e.g., using frequency division multiplexing). In some aspects, a scheduling assignment and associated data transmissions are not transmitted on adjacent RBs.

In some aspects, a UE 305 may operate using a transmission mode where resource selection and/or scheduling is performed by the UE 305 (e.g., rather than a base station 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy rate (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a modulation and coding scheme (MCS) to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

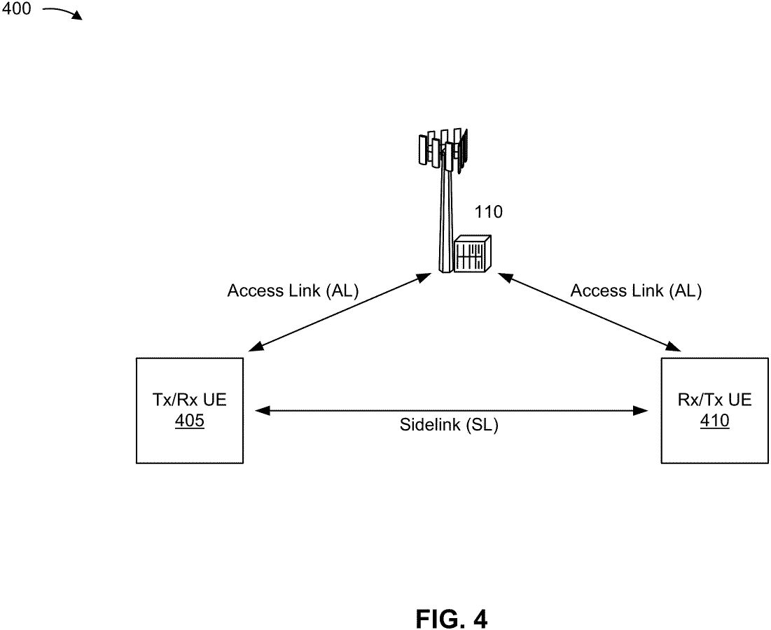

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link. Additionally, or alternatively, in some sidelink modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above, FIG. 4 is provided as an example. Other examples may differ from what is described with respect to FIG. 4.

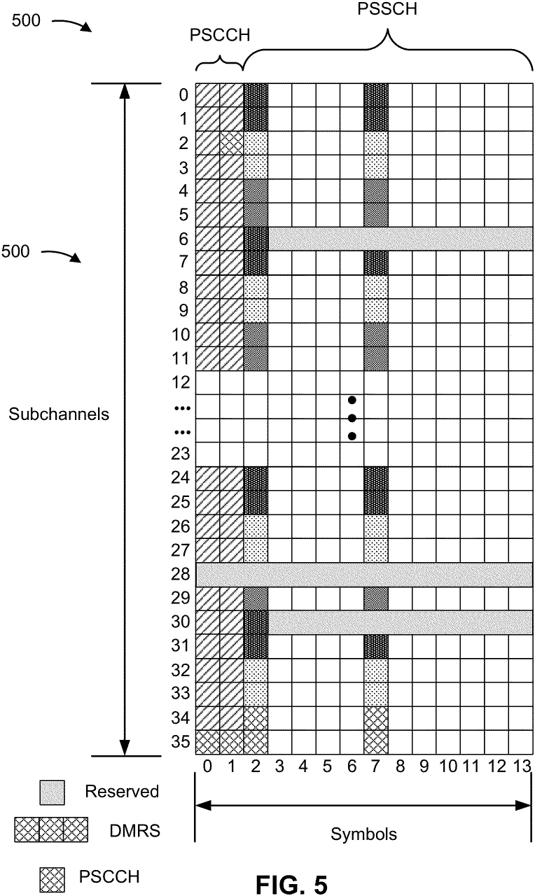

FIG. 5 is a diagram illustrating an example 500 of subcarrier tone reservation on one or more subcarriers, in accordance with the present disclosure. In some networks, a transmitting device (e.g., a transmitting UE) may transmit a sidelink communication on a physical sidelink shared channel (PSSCH) with tone reservation on one or more subcarriers based at least in part on measurement(s) of reference signals from a receiving device (e.g., a receiving UE), a request from the receiving device, an indication of a capability of the receiving device, and/or an independent determination by the transmitting device, among other examples (e.g., as described herein).

In some aspects, the receiving device may be configured to communicate with the transmitting device using a configuration for tone reservation. For example, the configuration may be common for multiple communications (e.g., for a unicast sidelink connection).

As shown by example 500, a PSSCH may include one or more reserved subcarriers (e.g., tones) on which data and/or pilots are not to be transmitted. In some aspects, the subcarriers may be empty (e.g., not having any information intended for transmission to the UE). Additionally, or alternatively, tone reservation signaling may be applied to physical downlink control channel (PSCCH) symbols (e.g., symbols 0 and 1 in FIG. 5). In some aspects, the tone reservation signaling may include a signal that is configured to improve a peak-to-average-power ratio (PAPR) for a sidelink communication on the PSSCH.

Configuring tone reservation may involve significant overhead that may decrease overall throughput. For example, to enable the receiving device to identify which subcarriers to discard (e.g., the reserved subcarriers), the transmitting device may explicitly indicate each of the frequency locations (e.g., using identifiers) of the subcarriers to the receiving device. This may consume communication, network, and power resources (e.g., bits) for the transmitting device to transmit (e.g., in sidelink control information) and for the receiving device to receive. Additionally, or alternatively, consumption of the network resources for the indications may decrease throughput available for data (e.g., associated with the PSSCH). In a communication where tone reservation is not used, an increase in PAPR may occur, which may degrade communications between the transmitting device and the receiving device, and may negatively affect an efficiency of power amplification at the transmitting device. Based at least in part on degradation of the communications, the transmitting device and/or the receiving device may consume power, communication, network, and computing resources to detect and/or correct communication errors associated with the degradation.

As indicated above, FIG. 5 is provided as an example. Other examples may differ from what is described with respect to FIG. 5.

In some aspects described herein, a transmitting device having a unicast sidelink connection (e.g., a cellular V2X connection) with a receiving device may obtain an estimated frequency response of a reception channel (e.g., a channel on which the transmitting device receives signaling from a receiving device). The transmitting device may apply tone reservation to one or more subcarriers based at least in part on the estimated frequency response. The transmitting device may transmit, to the receiving device on a transmission channel (e.g., a channel on which the transmitting device transmits signaling to a receiving device), one or more sidelink communications having the tone reservation applied. The receiving device may estimate a channel response of the transmission channel and decode the one or more downlink communications based at least in part on the tone reservation being applied on one or more subcarriers of the transmission channel. For example, the receiving device may zero out or rate match the one or more subcarriers of the transmission channel based at least in part on the one or more subcarriers having a lowest capacity or a lowest energy of subcarriers of the transmission channel.

FIG. 6 is a diagram illustrating an example 600 associated with subcarrier tone reservation, in accordance with the present disclosure. As shown in FIG. 6, a transmitting device (e.g., UE 120) may communicate with a receiving device (e.g., UE 120). In some aspects, the transmitting device and the receiving device may be part of a wireless network (e.g., wireless network 100). As shown in FIG. 6, the transmitting device may apply tone reservation for sidelink communications to the receiving device. A channel used for transmissions from the transmitting device to the receiving device is referred to as a transmission channel, and a channel used for transmissions from the receiving device to the transmitting device is referred to as a receiving channel.

The transmitting device and the receiving device may be configured with configuration information. In some aspects, the transmitting device and/or the receiving device may receive the configuration information via one or more of radio resource control (RRC) signaling, MAC control elements (MAC CEs), and/or downlink control information (DCI) from a base station (e.g., base station 110), among other examples. In some aspects, the configuration information may include an indication of one or more configuration parameters (e.g., already known to the transmitting device and/or the receiving device) for selection by the transmitting device and/or the receiving device, and/or explicit configuration information for the transmitting device and/or the receiving device to use to configure themselves, among other examples.

In some aspects, the configuration information may indicate that the transmitting device and/or the receiving device is to receive an indication that tone reservation is to be applied to one or more subcarriers for one or more sidelink communications. For example, the configuration information may indicate that the transmitting device and/or the receiving device is to receive the indication via SCI. In some aspects, the indication may include an indication of a number of subcarriers to which tone reservation is to be applied, a fraction of subcarriers to which tone reservation is to be applied, and/or a threshold power for subcarriers to which tone reservation is to be applied. In some aspects, the configuration information may indicate that the transmitting device and/or the receiving device is to transmit one or more uplink signals (e.g., sounding reference signals), using the one or more subcarriers, for measurement by the transmitting device. In some aspects, the configuration information may indicate that the transmitting device and/or the receiving device is to determine a channel response of the one or more sidelink communications (e.g., based at least on part on demodulation reference signals of the one or more sidelink communications) and determine that tone reservation is applied to the one or more subcarriers based at least in part on received energy (e.g., power) on the one or more subcarriers (e.g., based at least in part on the one or more subcarriers having a lowest received energy and/or a lowest capacity of subcarriers of the one or more sidelink communications).

In some aspects, the configuration information may indicate that the transmitting device and/or the receiving device is to receive the one or more sidelink communications having the tone reservation applied to the one or more subcarriers and that the one or more subcarriers have had tone reservation applied based at least in part on the measurement (e.g., by the transmitting device) of the one or more sidelink signals on the one or more subcarriers. In some aspects, the configuration information may indicate that the receiving device is to decode the one or more sidelink communications based at least in part on discarding samples measured on the one or more subcarriers (e.g., zeroing out log likelihood ratios (LLRs) for the one or more subcarriers). In some aspects, the configuration information may indicate that the receiving device is to transmit an indication of a measurement of one or more signal-to-interference-plus-noise ratios (SINRs) based at least in part on reception of one or more sidelink reference signals from the transmitting device.

As shown by reference number 610, the transmitting device and the receiving device may communicate indications of capabilities to communicate unicast sidelink one or more communications having tone reservation applied based at least in part on a frequency response of a reception channel. In some aspects, the transmitting device and the receiving device may communicate the indications as part of establishing the unicast sidelink connection. In some aspects, the transmitting device and the receiving device capabilities to receive the sidelink communications having the tone reservation applied may be based at least in part on configurations of the transmitting device and the receiving device, components of the transmitting device and the receiving device, and/or availability of resources of the transmitting device and the receiving device that may be used to determine subchannels to which tone reservation to be applied, or has been applied, within a threshold amount of time.

In some aspects, a capability of the receiving device or the capability of the transmitting device to communicate using the channel aware tone reservation for the unicast sidelink communication may be based at least in part on a capability to estimate a set of weakest subcarriers and decode the unicast sidelink communication based at least in part on the tone reservation being applied to the set of weakest subcarriers and/or one or more reciprocity-based parameters (e.g., reciprocity and/or channel response similarities between the transmission channel and the reception channel). In some aspects, a capability of the receiving device or the capability of the transmitting device to communicate using the channel aware tone reservation for the unicast sidelink communication may be based at least in part on an overlap in frequency between a first allocation for transmissions by the transmitting device and a second allocation for transmissions by the receiving device and/or a relative speed between the transmitting device and the receiving device.

As shown by reference number 615, the transmitting device may transmit, and the receiving device may receive, one or more sidelink reference signals and/or one or more other sidelink signals. In some aspects, the transmitting device may transmit one or more DMRSs for the receiving device to measure. The receiving device may measure the one or more sidelink signals to determine one or more SINRs associated with one or more channels via which the receiving device receives communications from the transmitting device.

As shown by reference number 620, the receiving device may transmit, and the transmitting device may receive, a measurement report. In some aspects, the receiving device may transmit, and the transmitting device may receive, a measurement of one or more SINRs that are based at least in part on reception of the one or more sidelink signals described in connection with reference number 615. In some aspects, the transmitting device may determine whether to use tone reservation for subsequent sidelink communications based at least in part on the measurement report. For example, the transmitting device may determine to use tone reservation based at least in part on a relatively low SINR (e.g., less than or equal to a threshold) and/or may determine to not use tone reservation based at least in part on a relatively high SINR (e.g., greater than or equal to a threshold). In some aspects, the transmitting device may determine an amount (e.g., a level or a degree) of tone reservation to apply based at least in part on the measurement report. For example, the transmitting device may determine a number of subcarriers to which tone reservation is to be applied, a fraction of subcarriers to which tone reservation is to be applied, or a threshold power for subcarriers to which tone reservation is to be applied based at least in part on the one or more SINRs indicated in the measurement report.

As shown by reference number 625, the transmitting device and the receiving device may communicate one or more indications that tone reservation is to be applied to one or more subcarriers for one or more sidelink communication. In some aspects, the receiving device and the transmitting device may communicate the one or more indications via SCI via a sidelink control channel and/or via a sidelink data channel.

In some aspects, the transmitting device may transmit, and the receiving device may receive, an indication that channel aware tone reservation is applied to the sidelink reference signals. Additionally, or alternatively, the receiving device may transmit, and the transmitting device may receive, an indication (e.g., a request) to apply channel aware tone reservation to the sidelink reference signals.

In some aspects, the indication that tone reservation is to be applied may include an indication of a number of subcarriers to which tone reservation is to be applied, a fraction (e.g., percentage) of subcarriers to which tone reservation is to be applied, a threshold power for subcarriers to which tone reservation is to be applied, a number of slots for which channel aware tone reservation is to be applied, and/or an indication of the subcarriers of the transmission channel that have tone reservation applied, among other examples. For example, the indication may include information that indicates that the N subcarriers with the lowest energy and/or power (e.g., based on signal-to-noise ratio (SNR) measurements, SINR measurements, and/or RSSI measurements) are to have tone reservation applied, where N is a positive integer. As another example, the indication may include information that indicates a fraction or percentage (e.g., one fourth, one tenth, 5%, 10%, 20%, or the like) of subcarriers to which tone reservation is to be applied (e.g., subcarriers in the bottom fourth, tenth, 5%, 10%, 20%, or the like, in energy and/or power). As yet another example, the indication may include information that indicates a threshold power (e.g., 0 dB, -5 dB, -10 dB, or the like), and that tone reservation is to be applied to subcarriers associated with uplink signals that fail to satisfy the threshold power.

In some aspects, the indication that tone reservation is to be applied may include information identifying a tone reservation optimization technique or formula. For example, based at least in part on the number of subcarriers, the fraction of subcarriers, and/or the threshold power for subcarriers to which tone reservation is to be applied, an optimization technique may be designed to identify subcarriers for tone reservation in a manner that optimizes PAPR with a constraint of a maximum power (e.g., transmit power) that is equal to the power used for the PSSCH and/or PSCCH subcarrier. In some aspects, the indication may include information that indicates that tone reservation optimization techniques are to be performed in iterations, are to be generated by applying machine learning, are to be generated using constrained or unconstrained optimization, or are to be generated by testing hypothesis iterations, among other examples. In some aspects, the indication may include information identifying a minimum tone reservation power constraint to be used (e.g., in a manner designed to improve receiving device detection).

In some aspects, the indication that tone reservation is to be applied may include information identifying a PAPR threshold to be achieved by tone reservation, and may include information indicating that various tone reservation and/or optimization techniques are to be used until the PAPR threshold is satisfied. For example, the indication may include information identifying the PAPR threshold and information indicating that the lowest energy subcarriers are to be iteratively discarded until the PAPR threshold is reached (e.g., starting with discarding the lowest 1% of subcarriers and incrementing by +1% until the PAPR threshold is satisfied).

As shown by reference number 630, the transmitting device may transmit, and the receiving device may receive, a request for sidelink reference signals. For example, the transmitting device may request the receiving device to transmit the reference signals over a bandwidth associated with the transmission channel. In some aspects, the transmission channel and the reception channel may have insufficient overlap to determine the channel response using reference signals transmitted via only the reception channel. Based at least in part on the transmitting device transmitting an indication to transmit the reference signals, the transmitting device may request the reference signals to be transmitted on a bandwidth that overlaps sufficiently (e.g., for reciprocity estimations) with the transmission channel. The transmitting device may request a burst (e.g., on a single symbol, two symbols, three symbols, and/or fewer than all symbols of a slot) of DMRSs or other reference signals.

As shown by reference number 635, the receiving device may transmit, and the transmitting device may receive, one or more uplink signals. In some aspects, the one or more uplink signals may be transmitted by the receiving device for measurement by the transmitting device (e.g., to enable the transmitting device to identify subcarriers to which tone reservation is to be applied). In some aspects, the one or more uplink signals include one or more sounding reference signals (SRSs) or other reference signals.

As shown by reference number 640, the transmitting device may apply tone reservation to one or more subcarriers based at least in part on received energy on the one or more uplink signals. In some aspects, the transmitting device may determine channel conditions (e.g., received energy measurements, one or more SINR values, and/or one or more PAPR values, among other examples) and/or estimate a frequency response of the reception channel based at least in part on the one or more uplink signals and apply tone reservation based at least in part on the channel conditions. In some aspects, the transmitting device may apply tone reservation to the one or more subcarriers based at least in part on the estimated frequency response of the reception channel and/or the channel conditions. For example, the transmitting device may apply tone reservation to the one or more subcarriers based at least in part on the one or more subcarriers having lowest received energies or lowest estimated capacities of subcarriers of the one or more reference signals. Additionally, or alternatively, the transmitting device may apply tone reservation to the one or more subcarriers based at least in part on channel conditions of a reception channel or the transmission channel, a relative speed between the transmitting device and the receiving device, a Doppler spread estimated from the sidelink reference signals, an allocation size, an allocation location in a frequency domain, and/or an estimated SINR of the transmission channel and/or the reception channel.

In some aspects, the transmitting device may apply tone reservation based at least in part on receiving the indication of the measurement of one or more SINRs (e.g., the measurement report described in connection with reference number 620) and/or based at least in part on reception of one or more sidelink reference signals (e.g., the sidelink signals described in connection with reference number 635).

In some aspects, the transmitting device may apply tone reservation to a number of subcarriers, a fraction (e.g., percentage) of subcarriers, and/or based at least in part on a threshold power for subcarriers, among other examples (e.g., as described herein). In some aspects, the transmitting device may apply tone reservation using a tone reservation optimization technique (e.g., as described herein). In some aspects, the transmitting device may apply tone reservation based at least in part on a PAPR threshold and/or various tone reservation and/or optimization techniques to be iteratively used until the PAPR threshold is satisfied (e.g., as described herein).

In some aspects, the transmitting device may prepare a report indicating whether tone reservation is applied and indicating a number of subcarrier(s) (e.g., fraction or percentage) to which tone reservation is applied. In some aspects, the tone reservation frequency locations (e.g., subcarrier identifiers) and corresponding values may be identified to a mapper, along with data and/or pilots for transmission to the receiving device (e.g., using OFDM transmission protocol (e.g., inverse fast Fourier transform (IFFT))). The mapper may map the data and/or pilots to subcarriers of the channel, excluding subcarriers to which tone reservation is applied.

In some aspects, the transmitting device may apply channel aware tone reservation (e.g., tone reservation that is based at least in part on an estimated frequency response of the reception channel and/or other parameters) along with fixed location tone reservation applied to the transmission channel. The fixed location tone reservation may be applied based at least in part on a configuration from a base station or other network entity.

As shown by reference number 645, the transmitting device may transmit, and the receiving device may receive, one or more unicast sidelink communications having the tone reservation applied based at least in part on the sidelink reference signals (e.g., applied to the one or more subcarriers). In some aspects, the transmitting device may also transmit (e.g., within the one or more unicast sidelink communications) an indication of the locations of the tone reservation subcarriers. For example, the transmitting device may indicate the locations with a reduced granularity by, for example, grouping consecutive subcarriers into subcarrier groups in which all or none of the subcarriers have tone reservation applied. Additionally, or alternatively, the transmitting device may transmit the indication of the locations of the tone reservation subcarriers as an uncompressed indication, or as a compressed indication using a lossless compression (e.g., using a compression scheme that is configured for the communication in a communication protocol or via communication between the transmitting device and the receiving device, among other examples).

As shown by reference number 650, the receiving device may estimate a channel response of the one or more unicast sidelink communications and/or that tone reservation is applied to the one or more subcarriers based at least in part on received energy on the one or more subcarriers. In some aspects, the receiving device may determine that tone reservation is applied to the one or more unicast sidelink communications based at least in part on the configuration information, the indication that tone reservation is to be applied (e.g., described above in connection with reference number 625), and/or a report included in the one or more sidelink communications, among other examples. In some aspects, the receiving device may determine the channel response based at least in part on DMRSs of the one or more sidelink communications (e.g., based at least in part on an estimation of the lowest energy subcarriers using the DMRSs).

In some aspects, the receiving device may determine that tone reservation is applied to the subcarrier(s) based at least in part on the subcarrier(s) having a lowest received energy of subcarriers used for the one or more sidelink communications. In some aspects, the receiving device may determine that tone reservation is applied to the one or more subcarriers based at least in part on information included in the indication that tone reservation is to be applied to the one or more subcarriers (e.g., described above in connection with reference number 625).

As shown by reference number 655, the receiving device may decode the one or more unicast sidelink communications. In some aspects, the receiving device may use information included in the indication that tone reservation is to be applied to the one or more unicast sidelink communications (e.g., described above in connection with reference number 625) to decode the one or more unicast sidelink communications. In some aspects, the receiving device may decode the one or more unicast sidelink communications based at least in part on discarding signals associated with the one or more subcarriers to which tone reservation was applied (e.g., zeroing out LLRs of samples associated with the one or more subcarriers).

As shown by reference number 660, the transmitting device and the receiving device may communicate an indication that tone reservation is not applied to one or more subsequent unicast sidelink communications. In some aspects, a configuration of application of tone reservation (e.g., channel aware tone reservation) indicated in connection with reference number 625 may apply to subsequent communications until the transmitting device and the receiving device communicate an indication that tone reservation is not applied to one or more subsequent unicast sidelink communications. In some aspects, the transmitting device and the receiving device communicate the indication that tone reservation is not applied to one or more subsequent unicast sidelink communications based at least in part on a change of channel conditions and/or an estimated frequency response of the transmission channel. In some aspects, tone reservation may be activated for a single slot, an indicated or configured number of slots, or until an indication to stop using tone reservation.

As indicated above, FIG. 6 is provided as an example. Other examples may differ from what is described with respect to FIG. 6.

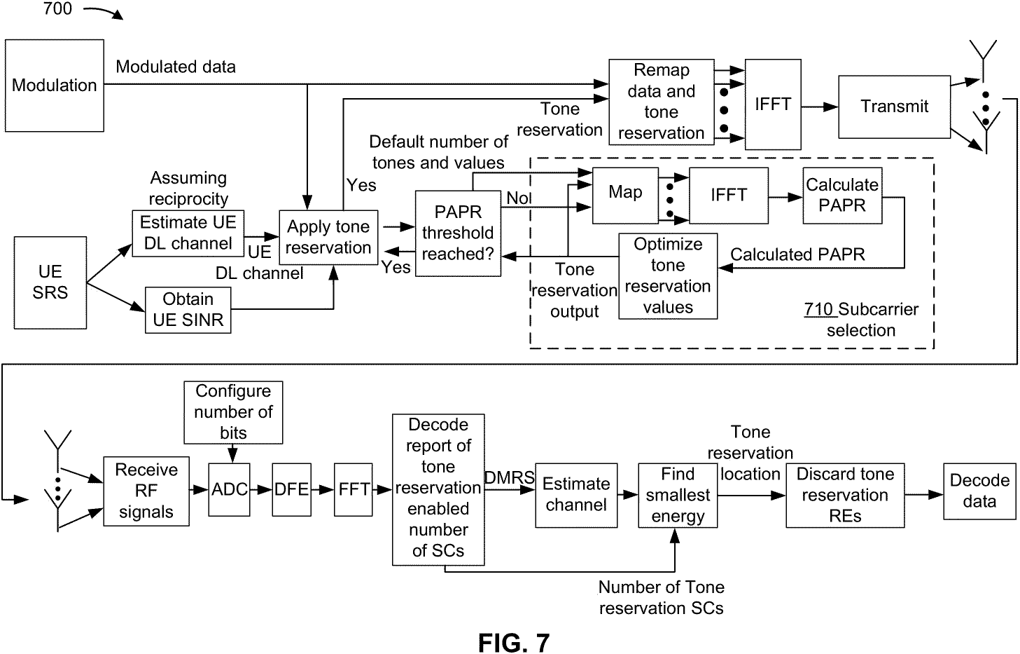

FIG. 7 is a diagram illustrating an example 700 of subcarrier tone reservation, in accordance with the present disclosure. As shown in FIG. 7, tone reservation may be applied to communications transmitted from a base station to a receiving device.

As shown in example 700, the transmitting device may measure one or more DMRSs to estimate a reception channel. The transmitting device may use the estimate of the reception channel to estimate a transmission channel (e.g., using an assumption of reciprocity between the reception channel and the transmission channel). In some aspects, the transmitting device may use the estimate of the transmission channel to determine subcarriers to which tone reservation is to be applied.

The transmitting device may determine that tone reservation is to be applied to one or more subcarriers for transmissions to the receiving device (e.g., based at least in part on an SINR reported by the receiving device, the reception channel estimate, other metrics associated with the reception channel or the transmission channel, network traffic, and/or an amount of data buffered for transmission to the receiving device). When the transmitting device determines that tone reservation is to be applied, the transmitting device may then determine which subcarriers are to be selected for tone reservation. In some aspects, selection of subcarriers may be based at least in part on a default number, such as the lowest 10% of subcarriers. In some aspects, selection of the default number may be based at least in part on the SINR measurements.

As shown by reference number 710, in some aspects, the transmitting device may iteratively perform subcarrier selection techniques until a threshold PAPR value is reached. For example, the transmitting device may use the transmission channel estimate, a default number of tones (e.g., subcarriers), and a default PAPR threshold to perform a selective mapping (SLM) technique, where alternative transmit sequence vectors (e.g., corresponding to the transmission channel) are generated from the same data source by multiplying the vectors by a random or pseudo-random phase. After multiplication, IFFT may be performed on the vectors to convert the corresponding signal from the frequency domain to the time domain, and PAPR values may be determined for each of the vectors. The PAPR values may be compared to one another in a manner designed to optimize tone reservation values by identifying a vector having tone reservations that result in a relatively low, or lowest, PAPR value with respect to other vectors. The transmitting device may then determine whether the PAPR threshold is satisfied by the tone reservations indicated in the identified vector.

In some aspects, the subcarrier selection process may be performed up to k iterations, where k is a positive integer, and/or until a PAPR value that satisfies the threshold is reached. For example, if a default value (e.g., an initial value) for the number of subcarriers to which tone reservation is to be applied is 5%, and the subcarrier selection output fails to satisfy the PAPR threshold by applying tone reservation to the lowest 5% of subcarriers, the transmitting device may increase the default value (e.g., by a fixed amount, variable amount, or fixed rate) and perform SLM again to determine if reserving the increased number of subcarriers (e.g., the lowest 7%) will satisfy the PAPR threshold. In some aspects, the PAPR threshold may be modified (e.g., lowered to decrease the number of subcarriers that would be reserved, or raised to increase the number of subcarriers that would be reserved) when iterating through the subcarrier selection process.

Once a tone reservation satisfying the PAPR threshold is identified, the transmitting device may use the identified tone reservation and modulated data to remap the modulated data using the identified tone reservation scheme (e.g., application of tone reservation on the identified subchannels). For example, in a situation where the subcarrier selection process indicates that the lowest 6% of subcarriers (e.g., in terms of SINR) should be reserved to meet a given PAPR threshold, the modulated data may only be mapped to the top 94% of subcarriers (e.g., based on received energy and/or power), leaving the bottom 6% reserved. After application of IFFT, the resulting communication may be transmitted to the receiving device.

The receiving device may receive the communication as radio frequency (RF) signals, and may use analog to digital conversion (ADC), using a configured number of bits, to provide digital output to a digital front end (DFE) of the receiving device. The receiving device may then apply a fast Fourier transform (FFT) algorithm to convert the received signals to a frequency domain and obtain the communication (e.g., DMRSs).

The receiving device may decode a report of the tone reservation (e.g., included in DCI), which may indicate a number of subcarriers to which tone reservation was applied. For example, the report may indicate that tone reservation is to be applied to the lowest 6% of subcarriers.

The receiving device may use the communication (e.g., DMRS) to estimate the energy (e.g., power) of the subcarriers of the transmission channel (e.g., using SINR). After identifying the smallest (e.g., lowest) energy subcarriers (e.g., the bottom 6%), the receiving device may discard the identified subcarriers and decode the remaining 94% of the data.

In this way, the transmitting device and the receiving device may communicate using tone reservation without the need to transmit reports to identify specific subcarriers to which tone reservation is to be applied. This may reduce overhead associated with the use of tone reservation by obviating the need to transmit reports for tone reservation, which may increase throughput between the receiving device and transmitting device. In addition, the application of tone reservation may lead to improved PAPR, which may conserve resources that the receiving device uses to receive (e.g., demodulate, decode, and/or the like) the communication and may also lead to improved efficiency of power amplification at the transmitting device (e.g., by conserving power that would otherwise be used to transmit reserved subcarriers).

As indicated above, FIG. 7 is provided as an example. Other examples may differ from what is described with respect to FIG. 7.

FIG. 8 is a diagram illustrating an example process 800 performed, for example, by a transmitting device, in accordance with the present disclosure. Example process 800 is an example where the transmitting device (e.g., UE 120) performs operations associated with channel aware tone reservation for sidelink communications.

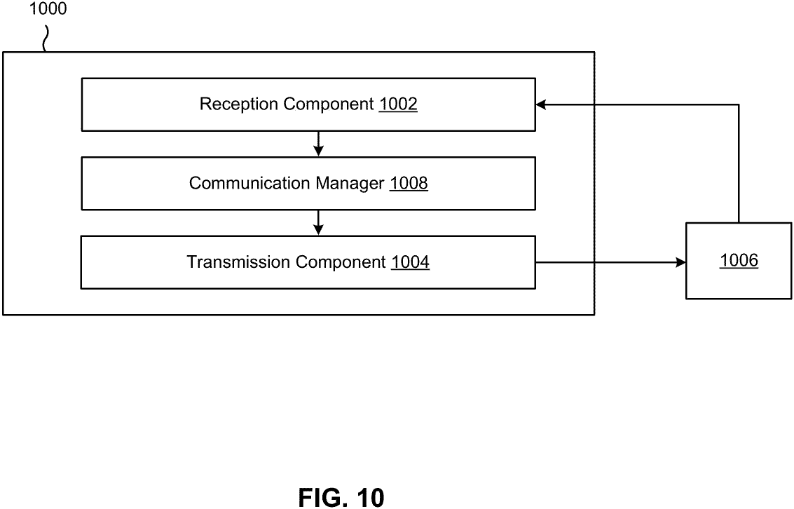

As shown in FIG. 8, in some aspects, process 800 may include receiving sidelink reference signals from a receiving device (block 810). For example, the transmitting device (e.g., using communication manager 140 and/or reception component 1002, depicted in FIG. 10) may receive sidelink reference signals from a receiving device, as described above.

As further shown in FIG. 8, in some aspects, process 800 may include transmitting, to the receiving device and via a transmission channel, a unicast sidelink communication having tone reservation applied based at least in part on the sidelink reference signals (block 820). For example, the transmitting device (e.g., using communication manager 140 and/or transmission component 1004, depicted in FIG. 10) may transmit, to the receiving device and via a transmission channel, a unicast sidelink communication having tone reservation applied based at least in part on the sidelink reference signals, as described above.

Process 800 may include additional aspects, such as any single aspect or any combination of aspects described below and/or in connection with one or more other processes described elsewhere herein.

In a first aspect, process 800 includes estimating a frequency response of a reception channel based at least in part on the sidelink reference signals, and applying the tone reservation to the transmission channel based at least in part on the estimated frequency response of the reception channel.

In a second aspect, alone or in combination with the first aspect, applying the tone reservation to the transmission channel based at least in part on the frequency response of the reception channel comprises applying the tone reservation to a set of subcarriers of the transmission channel based at least in part on measured energy or estimated capacity on the set of subcarriers of the transmission channel.

In a third aspect, alone or in combination with one or more of the first and second aspects, application of the tone reservation is based at least in part on a set of parameters comprising one or more of channeling conditions of a reception channel or the transmission channel, a relative speed between the transmitting device and the receiving device, a Doppler spread estimated from the sidelink reference signals, an allocation size, an allocation location in a frequency domain, or an estimated SINR.

In a fourth aspect, alone or in combination with one or more of the first through third aspects, process 800 includes transmitting a request for the receiving device to transmit the sidelink reference signals over a bandwidth associated with the transmission channel.

In a fifth aspect, alone or in combination with one or more of the first through fourth aspects, process 800 includes establishing a unicast link with the receiving device before receiving the sidelink reference signals.

In a sixth aspect, alone or in combination with one or more of the first through fifth aspects, process 800 includes one or more of receiving, before transmitting the unicast sidelink communication, a first indication of a capability of the receiving device to communicate using channel aware tone reservation for the unicast sidelink communication, or transmitting, before transmitting the unicast sidelink communication, a second indication of a capability of the transmitting device to communicate using the channel aware tone reservation for the unicast sidelink communication.

In a seventh aspect, alone or in combination with one or more of the first through sixth aspects, the capability of the receiving device or the capability of the transmitting device to communicate using the channel aware tone reservation for the unicast sidelink communication is based at least in part on one or more of a capability to estimate a set of weakest subcarriers and decode the unicast sidelink communication based at least in part on the tone reservation being applied to the set of weakest subcarriers, one or more reciprocity-based parameters, an overlap in frequency between a first allocation for transmissions by the transmitting device and a second allocation for transmissions by the receiving device, or a relative speed between the transmitting device and the receiving device.

In an eighth aspect, alone or in combination with one or more of the first through seventh aspects, process 800 includes one or more of receiving, via the receiving device, a first indication to apply channel aware tone reservation to the sidelink reference signals, or transmitting, to the receiving device, a second indication that channel aware tone reservation is applied to the sidelink reference signals.

In a ninth aspect, alone or in combination with one or more of the first through eighth aspects, receiving the first indication or transmitting the second indication comprises one or more of receiving the first indication via a sidelink control channel, transmitting the second indication via a sidelink control channel, receiving the first indication via a sidelink data channel, or transmitting the second indication via a sidelink data channel.

In a tenth aspect, alone or in combination with one or more of the first through ninth aspects, the second indication comprises one or more of an indication that channel aware tone reservation is applied to the unicast sidelink communication, an indication of a number of subcarriers of the transmission channel that have tone reservation applied, a number of slots for which channel aware tone reservation is applied, or an indication of the subcarriers of the transmission channel that have tone reservation applied.

In an eleventh aspect, alone or in combination with one or more of the first through tenth aspects, process 800 includes transmitting an indication that a subsequent unicast sidelink communication does not have tone reservation applied.

In a twelfth aspect, alone or in combination with one or more of the first through eleventh aspects, transmitting the unicast sidelink communication having the tone reservation applied comprises transmitting the unicast sidelink communication having channel aware tone reservation applied and having fixed location tone reservation applied to the transmission channel.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a receiving device, in accordance with the present disclosure. Example process 900 is an example where the receiving device (e.g., UE 120) performs operations associated with channel aware tone reservation for sidelink communications.

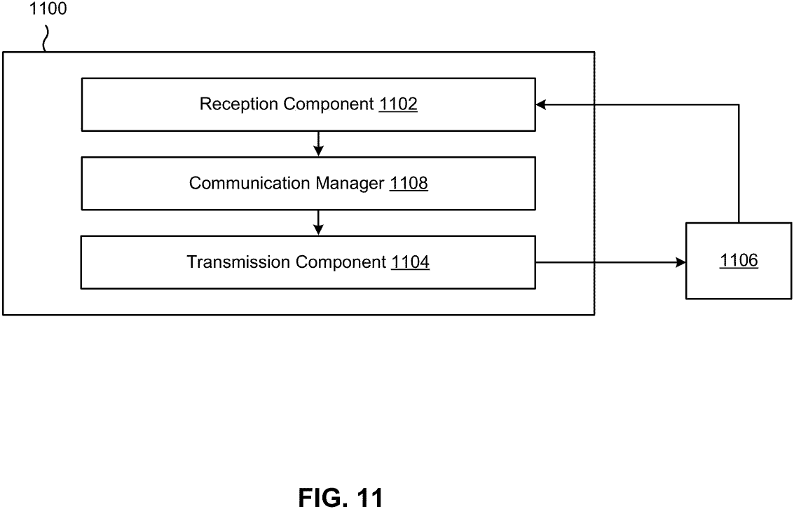

As shown in FIG. 9, in some aspects, process 900 may include transmitting sidelink reference signals to a transmitting device (block 910). For example, the receiving device (e.g., using communication manager 140 and/or transmission component 1104, depicted in FIG. 11) may transmit sidelink reference signals to a transmitting device, as described above.

As further shown in FIG. 9, in some aspects, process 900 may include receiving, from the transmitting device and via a transmission channel, a unicast sidelink communication having tone reservation applied based at least in part on the sidelink reference signals (block 920). For example, the receiving device (e.g., using communication manager 140 and/or reception component 1102, depicted in FIG. 11) may receive, from the transmitting device and via a transmission channel, a unicast sidelink communication having tone reservation applied based at least in part on the sidelink reference signals, as described above.

Process 900 may include additional aspects, such as any single aspect or any combination of aspects described below and/or in connection with one or more other processes described elsewhere herein.

In a first aspect, process 900 includes estimating a frequency response of a transmission channel based at least in part on measurement of the unicast sidelink communication, and decoding the unicast sidelink communication based at least in part on the tone reservation being applied to a set of weakest subcarriers of the transmission channel.

In a second aspect, alone or in combination with the first aspect, the set of weakest subcarriers of the transmission channel are weakest based at least in part on measured energy or estimated capacity on the set of weakest subcarriers of the transmission channel.

In a third aspect, alone or in combination with one or more of the first and second aspects, application of the tone reservation is based at least in part on a set of parameters comprising one or more of channeling conditions of a reception channel or the transmission channel, a relative speed between the transmitting device and the receiving device, a Doppler spread estimated from the sidelink reference signals, an allocation size, an allocation location in a frequency domain, or an estimated SINR.

In a fourth aspect, alone or in combination with one or more of the first through third aspects, process 900 includes receiving a request for the receiving device to transmit the sidelink reference signals over a bandwidth associated with the transmission channel.

In a fifth aspect, alone or in combination with one or more of the first through fourth aspects, process 900 includes establishing a unicast link with the transmitting device before transmitting the sidelink reference signals.

In a sixth aspect, alone or in combination with one or more of the first through fifth aspects, process 900 includes one or more of transmitting, before receiving the unicast sidelink communication, a first indication of a capability of the receiving device to communicate using channel aware tone reservation for the unicast sidelink communication, or receiving, before receiving the unicast sidelink communication, a second indication of a capability of the transmitting device to communicate using the channel aware tone reservation for the unicast sidelink communication.

In a seventh aspect, alone or in combination with one or more of the first through sixth aspects, the capability of the receiving device or the capability of the transmitting device to communicate using the channel aware tone reservation for the unicast sidelink communication is based at least in part on one or more of a capability to estimate a set of weakest subcarriers and decode the unicast sidelink communication based at least in part on the tone reservation being applied to the set of weakest subcarriers, one or more reciprocity-based parameters, an overlap in frequency between a first allocation for transmissions by the transmitting device and a second allocation for transmissions by the receiving device, or a relative speed between the transmitting device and the receiving device.

In an eighth aspect, alone or in combination with one or more of the first through seventh aspects, process 900 includes one or more of transmitting, to the transmitting device, a first indication to apply channel aware tone reservation to the sidelink reference signals, or receiving, from the transmitting device, a second indication that channel aware tone reservation is applied to the sidelink reference signals.

In a ninth aspect, alone or in combination with one or more of the first through eighth aspects, transmitting the first indication or receiving the second indication comprises one or more of transmitting the first indication via a sidelink control channel, receiving the second indication via a sidelink control channel, transmitting the first indication via a sidelink data channel, or receiving the second indication via a sidelink data channel.

In a tenth aspect, alone or in combination with one or more of the first through ninth aspects, the second indication comprises one or more of an indication that channel aware tone reservation is applied to the sidelink reference signals, an indication of a number of subcarriers of the transmission channel that have tone reservation applied, a number of slots for which channel aware tone reservation is applied, or an indication of the subcarriers of the transmission channel that have tone reservation applied.

In an eleventh aspect, alone or in combination with one or more of the first through tenth aspects, process 900 includes receiving an indication that a subsequent unicast sidelink communication does not have tone reservation applied.

In a twelfth aspect, alone or in combination with one or more of the first through eleventh aspects, receiving the unicast sidelink communication having the tone reservation applied comprises receiving the unicast sidelink communication having channel aware tone reservation applied and having fixed location tone reservation applied to the transmission channel.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a transmitting device, or a transmitting device may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a communication manager 1008 (e.g., the communication manager 140).

In some aspects, the apparatus 1000 may be configured to perform one or more operations described herein in connection with FIGS. 6 and 7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the transmitting device described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the transmitting device described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the transmitting device described in connection with FIG. 2. In some aspects, the transmission component 1004 may be co-located with the reception component 1002 in a transceiver.

The reception component 1002 may receive sidelink reference signals from a receiving device. The transmission component 1004 may transmit, to the receiving device and via a transmission channel, a unicast sidelink communication having tone reservation applied based at least in part on the sidelink reference signals.

The communication manager 1008 may estimate a frequency response of a reception channel based at least in part on the sidelink reference signals.

The communication manager 1008 and/or the transmission component 1004 may apply the tone reservation to the transmission channel based at least in part on the estimated frequency response of the reception channel.

The transmission component 1004 may transmit a request for the receiving device to transmit the sidelink reference signals over a bandwidth associated with the transmission channel.

The communication manager 1008 may establish a unicast link with the receiving device before receiving the sidelink reference signals.

The transmission component 1004 may transmit an indication that a subsequent unicast sidelink communication does not have tone reservation applied.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a receiving device, or a receiving device may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include a communication manager 1108 (e.g., the communication manager 140).

In some aspects, the apparatus 1100 may be configured to perform one or more operations described herein in connection with FIGS. 6 and 7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the receiving device described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the receiving device described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the receiving device described in connection with FIG. 2. In some aspects, the transmission component 1104 may be co-located with the reception component 1102 in a transceiver.

The transmission component 1104 may transmit sidelink reference signals to a transmitting device. The reception component 1102 may receive, from the transmitting device and via a transmission channel, a unicast sidelink communication having tone reservation applied based at least in part on the sidelink reference signals.

The communication manager 1108 may estimate a frequency response of a transmission channel based at least in part on measurement of the unicast sidelink communication.

The communication manager 1108 may decode the unicast sidelink communication based at least in part on the tone reservation being applied to a set of weakest subcarriers of the transmission channel.

The reception component 1102 may receive a request for the receiving device to transmit the sidelink reference signals over a bandwidth associated with the transmission channel.

The communication manager 1108 may establish a unicast link with the transmitting device before transmitting the sidelink reference signals.

The reception component 1102 may receive an indication that a subsequent unicast sidelink communication does not have tone reservation applied.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a transmitting device, comprising: receiving sidelink reference signals from a receiving device; and transmitting, to the receiving device and via a transmission channel, a unicast sidelink communication having tone reservation applied based at least in part on the sidelink reference signals.

Aspect 2: The method of Aspect 1, further comprising: estimating a frequency response of a reception channel based at least in part on the sidelink reference signals; and applying the tone reservation to the transmission channel based at least in part on the estimated frequency response of the reception channel.

Aspect 3: The method of Aspect 2, wherein applying the tone reservation to the transmission channel based at least in part on the frequency response of the reception channel comprises: applying the tone reservation to a set of subcarriers of the transmission channel based at least in part on measured energy or estimated capacity on the set of subcarriers of the transmission channel.

Aspect 4: The method of any of Aspects 1-3, wherein application of the tone reservation is based at least in part on a set of parameters comprising one or more of: channel conditions of a reception channel or the transmission channel, a relative speed between the transmitting device and the receiving device, a Doppler spread estimated from the sidelink reference signals, an allocation size, an allocation location in a frequency domain, or an estimated signal-to-interference-plus-noise-ratio.

Aspect 5: The method of any of Aspects 1-4, further comprising: transmitting a request for the receiving device to transmit the sidelink reference signals over a bandwidth associated with the transmission channel.

Aspect 6: The method of any of Aspects 1-5, further comprising: establishing a unicast link with the receiving device before receiving the sidelink reference signals.

Aspect 7: The method of any of Aspects 1-6, further comprising one or more of: receiving, before transmitting the unicast sidelink communication, a first indication of a capability of the receiving device to communicate using channel aware tone reservation for the unicast sidelink communication, or transmitting, before transmitting the unicast sidelink communication, a second indication of a capability of the transmitting device to communicate using the channel aware tone reservation for the unicast sidelink communication.

Aspect 8: The method of Aspect 7, wherein the capability of the receiving device or the capability of the transmitting device to communicate using the channel aware tone reservation for the unicast sidelink communication is based at least in part on one or more of: a capability to estimate a set of weakest subcarriers and decode the unicast sidelink communication based at least in part on the tone reservation being applied to the set of weakest subcarriers, one or more reciprocity-based parameters, an overlap in frequency between a first allocation for transmissions by the transmitting device and a second allocation for transmissions by the receiving device, or a relative speed between the transmitting device and the receiving device.

Aspect 9: The method of any of Aspects 1-8, further comprising one or more of: receiving, via the receiving device, a first indication to apply channel aware tone reservation to the sidelink reference signals, or transmitting, to the receiving device, a second indication that channel aware tone reservation is applied to the sidelink reference signals.

Aspect 10: The method of Aspect 9, wherein receiving the first indication or transmitting the second indication comprises one or more of: receiving the first indication via a sidelink control channel, transmitting the second indication via a sidelink control channel, receiving the first indication via a sidelink data channel, or transmitting the second indication via a sidelink data channel.

Aspect 11: The method of any of Aspects 9-10, wherein the second indication comprises one or more of: an indication that channel aware tone reservation is applied to the unicast sidelink communication, an indication of a number of subcarriers of the transmission channel that have tone reservation applied, a number of slots for which channel aware tone reservation is applied, or an indication of the subcarriers of the transmission channel that have tone reservation applied.

Aspect 12: The method of any of Aspects 1-11, further comprising: transmitting an indication that a subsequent unicast sidelink communication does not have tone reservation applied.

Aspect 13: The method of any of Aspects 1-12, wherein transmitting the unicast sidelink communication having the tone reservation applied comprises: transmitting the unicast sidelink communication having channel aware tone reservation applied and having fixed location tone reservation applied to the transmission channel.

Aspect 14: A method of wireless communication performed by a receiving device, comprising: transmitting sidelink reference signals to a transmitting device; and receiving, from the transmitting device and via a transmission channel, a unicast sidelink communication having tone reservation applied based at least in part on the sidelink reference signals.

Aspect 15: The method of Aspect 14, further comprising: estimating a frequency response of a transmission channel based at least in part on measurement of the unicast sidelink communication; and decoding the unicast sidelink communication based at least in part on the tone reservation being applied to a set of weakest subcarriers of the transmission channel.

Aspect 16: The method of Aspect 15, wherein the set of weakest subcarriers of the transmission channel are weakest based at least in part on measured energy or estimated capacity on the set of weakest subcarriers of the transmission channel.

Aspect 17: The method of any of Aspects 14-16, wherein application of the tone reservation is based at least in part on a set of parameters comprising one or more of: channel conditions of a reception channel or the transmission channel, a relative speed between the transmitting device and the receiving device, a Doppler spread estimated from the sidelink reference signals, an allocation size, an allocation location in a frequency domain, or an estimated signal-to-interference-plus-noise-ratio.

Aspect 18: The method of any of Aspects 14-17, further comprising: receiving a request for the receiving device to transmit the sidelink reference signals over a bandwidth associated with the transmission channel.

Aspect 19: The method of any of Aspects 14-18, further comprising: establishing a unicast link with the transmitting device before transmitting the sidelink reference signals.

Aspect 20: The method of any of Aspects 14-19, further comprising one or more of: transmitting, before receiving the unicast sidelink communication, a first indication of a capability of the receiving device to communicate using channel aware tone reservation for the unicast sidelink communication, or receiving, before receiving the unicast sidelink communication, a second indication of a capability of the transmitting device to communicate using the channel aware tone reservation for the unicast sidelink communication.

Aspect 21: The method of Aspect 20, wherein the capability of the receiving device or the capability of the transmitting device to communicate using the channel aware tone reservation for the unicast sidelink communication is based at least in part on one or more of: a capability to estimate a set of weakest subcarriers and decode the unicast sidelink communication based at least in part on the tone reservation being applied to the set of weakest subcarriers, one or more reciprocity-based parameters, an overlap in frequency between a first allocation for transmissions by the transmitting device and a second allocation for transmissions by the receiving device, or a relative speed between the transmitting device and the receiving device.

Aspect 22: The method of any of Aspects 14-21, further comprising one or more of: transmitting, to the transmitting device, a first indication to apply channel aware tone reservation to the sidelink reference signals, or receiving, from the transmitting device, a second indication that channel aware tone reservation is applied to the sidelink reference signals.

Aspect 23: The method of Aspect 22, wherein transmitting the first indication or receiving the second indication comprises one or more of: transmitting the first indication via a sidelink control channel, receiving the second indication via a sidelink control channel, transmitting the first indication via a sidelink data channel, or receiving the second indication via a sidelink data channel.

Aspect 24: The method of any of Aspects 22-23, wherein the second indication comprises one or more of: an indication that channel aware tone reservation is applied to the sidelink reference signals, an indication of a number of subcarriers of the transmission channel that have tone reservation applied, a number of slots for which channel aware tone reservation is applied, or an indication of the subcarriers of the transmission channel that have tone reservation applied.

Aspect 25: The method of any of Aspects 14-24, further comprising: receiving an indication that a subsequent unicast sidelink communication does not have tone reservation applied.

Aspect 26: The method of any of Aspects 14-25, wherein receiving the unicast sidelink communication having the tone reservation applied comprises: receiving the unicast sidelink communication having channel aware tone reservation applied and having fixed location tone reservation applied to the transmission channel.

Aspect 27: An apparatus for wireless communication at a device, comprising a processor; memory coupled with the processor; and instructions stored in the memory and executable by the processor to cause the apparatus to perform the method of one or more of Aspects 1-26.

Aspect 28: A device for wireless communication, comprising a memory and one or more processors coupled to the memory, the one or more processors configured to perform the method of one or more of Aspects 1-26.

Aspect 29: An apparatus for wireless communication, comprising at least one means for performing the method of one or more of Aspects 1-26.

Aspect 30: A non-transitory computer-readable medium storing code for wireless communication, the code comprising instructions executable by a processor to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to "at least one of “a list of items refers to any combination of those items, including single members. As an example, “at least one of: a, b, or c” is intended to cover a, b, c, a + b, a + c, b + c, and a + b + c, as well as any combination with multiples of the same element (e.g., a + a, a + a + a, a + a + b, a + a + c, a + b+b, a + c + c, b + b, b + b + b, b + b + c, c + c, and c + c + c, or any other ordering of a, b, and c).

No element, act, or instruction used herein should be construed as critical or essential unless explicitly described as such. Also, as used herein, the articles "a" and "an" are intended to include one or more items and may be used interchangeably with "one or more." Further, as used herein, the article "the" is intended to include one or more items referenced in connection with the article "the" and may be used interchangeably with "the one or more." Furthermore, as used herein, the terms "set" and "group" are intended to include one or more items and may be used interchangeably with "one or more." Where only one item is intended, the phrase "only one" or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A transmitting device for wireless communication, comprising:
a memory; and
one or more processors, coupled to the memory, configured to:
receive sidelink reference signals from a receiving device; and
transmit, to the receiving device and via a transmission channel, a unicast sidelink communication having tone reservation applied based at least in part on the sidelink reference signals.

2. The transmitting device of claim 1, wherein the one or more processors are further configured to:
estimate a frequency response of a reception channel based at least in part on the sidelink reference signals; and
apply the tone reservation to the transmission channel based at least in part on the estimated frequency response of the reception channel.

3. The transmitting device of claim 2, wherein the one or more processors, to apply the tone reservation to the transmission channel based at least in part on the frequency response of the reception channel, are configured to:
apply the tone reservation to a set of subcarriers of the transmission channel based at least in part on measured energy or estimated capacity on the set of subcarriers of the transmission channel.

4. The transmitting device of claim 1, wherein application of the tone reservation is based at least in part on a set of parameters comprising one or more of:
channel conditions of a reception channel or the transmission channel,
a relative speed between the transmitting device and the receiving device,
a Doppler spread estimated from the sidelink reference signals,
an allocation size,
an allocation location in a frequency domain, or
an estimated signal-to-interference-plus-noise-ratio.

5. The transmitting device of claim 1, wherein the one or more processors are further configured to:
transmit a request for the receiving device to transmit the sidelink reference signals over a bandwidth associated with the transmission channel.

6. The transmitting device of claim 1, wherein the one or more processors are further configured to:
establish a unicast link with the receiving device before receiving the sidelink reference signals.

7. The transmitting device of claim 1, wherein the one or more processors are further configured to one or more of:
receive, before transmitting the unicast sidelink communication, a first indication of a capability of the receiving device to communicate using channel aware tone reservation for the unicast sidelink communication, or
transmit, before transmitting the unicast sidelink communication, a second indication of a capability of the transmitting device to communicate using the channel aware tone reservation for the unicast sidelink communication.

8. The transmitting device of claim 7, wherein the capability of the receiving device or the capability of the transmitting device to communicate using the channel aware tone reservation for the unicast sidelink communication is based at least in part on one or more of:
a capability to estimate a set of weakest subcarriers and decode the unicast sidelink communication based at least in part on the tone reservation being applied to the set of weakest subcarriers,
one or more reciprocity-based parameters,
an overlap in frequency between a first allocation for transmissions by the transmitting device and a second allocation for transmissions by the receiving device, or
a relative speed between the transmitting device and the receiving device.

9. The transmitting device of claim 1, wherein the one or more processors are further configured to one or more of:
receive, via the receiving device, a first indication to apply channel aware tone reservation to the sidelink reference signals, or
transmit, to the receiving device, a second indication that channel aware tone reservation is applied to the sidelink reference signals.

10. The transmitting device of claim 9, wherein the one or more processors, to receive the first indication or transmitting the second indication, are configured to:
receive the first indication via a sidelink control channel,
transmit the second indication via a sidelink control channel,
receive the first indication via a sidelink data channel, or
transmit the second indication via a sidelink data channel.

11. The transmitting device of claim 9, wherein the second indication comprises one or more of:
an indication that channel aware tone reservation is applied to the unicast sidelink communication,
an indication of a number of subcarriers of the transmission channel that have tone reservation applied,
a number of slots for which channel aware tone reservation is applied, or
an indication of the subcarriers of the transmission channel that have tone reservation applied.

12. The transmitting device of claim 1, wherein the one or more processors are further configured to:
transmit an indication that a subsequent unicast sidelink communication does not have tone reservation applied.

13. The transmitting device of claim 1, wherein the one or more processors, to transmit the unicast sidelink communication having the tone reservation applied, are configured to:
transmit the unicast sidelink communication having channel aware tone reservation applied and having fixed location tone reservation applied to the transmission channel.

14. A receiving device for wireless communication, comprising:
a memory; and
one or more processors, coupled to the memory, configured to:
transmit sidelink reference signals to a transmitting device; and
receive, from the transmitting device and via a transmission channel, a unicast sidelink communication having tone reservation applied based at least in part on the sidelink reference signals.

15. The receiving device of claim 14, wherein the one or more processors are further configured to:
estimate a frequency response of a transmission channel based at least in part on measurement of the unicast sidelink communication; and
decode the unicast sidelink communication based at least in part on the tone reservation being applied to a set of weakest subcarriers of the transmission channel.

16. The receiving device of claim 15, wherein the set of weakest subcarriers of the transmission channel are weakest based at least in part on measured energy or estimated capacity on the set of weakest subcarriers of the transmission channel.

17. The receiving device of claim 14, wherein application of the tone reservation is based at least in part on a set of parameters comprising one or more of:
channel conditions of a reception channel or the transmission channel,
a relative speed between the transmitting device and the receiving device,
a Doppler spread estimated from the sidelink reference signals,
an allocation size,
an allocation location in a frequency domain, or
an estimated signal-to-interference-plus-noise-ratio.

18. The receiving device of claim 14, wherein the one or more processors are further configured to:
receive a request for the receiving device to transmit the sidelink reference signals over a bandwidth associated with the transmission channel.

19. The receiving device of claim 14, wherein the one or more processors are further configured to:
establish a unicast link with the transmitting device before transmitting the sidelink reference signals.

20. The receiving device of claim 14, wherein the one or more processors are further configured to one or more of:
transmit, before receiving the unicast sidelink communication, a first indication of a capability of the receiving device to communicate using channel aware tone reservation for the unicast sidelink communication, or
receive, before receiving the unicast sidelink communication, a second indication of a capability of the transmitting device to communicate using the channel aware tone reservation for the unicast sidelink communication.

21. The receiving device of claim 20, wherein the capability of the receiving device or the capability of the transmitting device to communicate using the channel aware tone reservation for the unicast sidelink communication is based at least in part on one or more of:
a capability to estimate a set of weakest subcarriers and decode the unicast sidelink communication based at least in part on the tone reservation being applied to the set of weakest subcarriers,
one or more reciprocity-based parameters,
an overlap in frequency between a first allocation for transmissions by the transmitting device and a second allocation for transmissions by the receiving device, or
a relative speed between the transmitting device and the receiving device.

22. The receiving device of claim 14, wherein the one or more processors are further configured to one or more of:
transmit, to the transmitting device, a first indication to apply channel aware tone reservation to the sidelink reference signals, or
receive, from the transmitting device, a second indication that channel aware tone reservation is applied to the sidelink reference signals.

23. The receiving device of claim 22, wherein the one or more processors, to transmit the first indication or receiving the second indication, are configured to:
transmit the first indication via a sidelink control channel,
receive the second indication via a sidelink control channel,
transmit the first indication via a sidelink data channel, or
receive the second indication via a sidelink data channel.

24. The receiving device of claim 22, wherein the second indication comprises one or more of:
an indication that channel aware tone reservation is applied to the sidelink reference signals,
an indication of a number of subcarriers of the transmission channel that have tone reservation applied,
a number of slots for which channel aware tone reservation is applied, or
an indication of the subcarriers of the transmission channel that have tone reservation applied.

25. The receiving device of claim 14, wherein the one or more processors are further configured to:
receive an indication that a subsequent unicast sidelink communication does not have tone reservation applied.

26. The receiving device of claim 14, wherein the one or more processors, to receive the unicast sidelink communication having the tone reservation applied, are configured to:
receive the unicast sidelink communication having channel aware tone reservation applied and having fixed location tone reservation applied to the transmission channel.

27. A method of wireless communication performed by a transmitting device, comprising:
receiving sidelink reference signals from a receiving device; and
transmitting, to the receiving device and via a transmission channel, a unicast sidelink communication having tone reservation applied based at least in part on the sidelink reference signals.

28. The method of claim 27, further comprising:
estimating a frequency response of a reception channel based at least in part on the sidelink reference signals; and
applying the tone reservation to the transmission channel based at least in part on the estimated frequency response of the reception channel.

29. A method of wireless communication performed by a receiving device, comprising:
transmitting sidelink reference signals to a transmitting device; and
receiving, from the transmitting device and via a transmission channel, a unicast sidelink communication having tone reservation applied based at least in part on the sidelink reference signals.

30. The method of claim 29, further comprising:
estimating a frequency response of a transmission channel based at least in part on measurement of the unicast sidelink communication; and
decoding the unicast sidelink communication based at least in part on the tone reservation being applied to a set of weakest subcarriers of the transmission channel.
